(19) United States
(12) Patent Application Publication
(10) Pub. No.: US 2012/0130836 A1
(43) Pub. Date: May 24, 2012

(54) MECHANISM FOR EFFICIENTLY MATCHING TWO OR MORE ENTITIES BASED ON MUTUAL BENEFIT

(76) Inventors: William A. Asperi, Parker, CO (US); Svetlana B. Belykh, Denver, CO (US)

(21) Appl. No.: 13/299,209

(22) Filed: Nov. 17, 2011

Related U.S. Application Data
(60) Provisional application No. 61/415,245, filed on Nov. 18, 2010.

(51) Int. Cl. G06Q 30/06

(52) U.S. Cl. 705/26.1

(57) ABSTRACT

The present inventive concept is generally directed to a computer-based system and associated methods for facilitating business referrals, matching consumers with compatible providers of goods and/or services. In an embodiment, the system comprises a business-referral website through which consumers can place bids for any product or service whatsoever. In an embodiment, there are functional modules designed to serve the following actors: Consumers, Goods/Service Providers, System Administrators, and sales/Marketing Agents. The system allows Consumers who are looking for a particular good or service to publish a “Bid” within the system, which in turn will logically match the Consumer offering with one or more Providers based on the Consumer-offer details; that is, product/service category and description, geographical area for delivery of the needed goods/services, and the offered price. Matched Providers are given the opportunity to electronically respond to the Consumer offer by accepting, rejecting, requesting more information, or counter-offering.

### CROSS-REFERENCE TO RELATED APPLICATIONS

The present patent application claims the benefit of U.S. Patent Application No. 61/415,245, filed on Nov. 18, 2010, for “Mechanism for Efficiently Matching Two or More Entities Based on Mutual Benefit”, and hereby incorporates by reference U.S. Patent Application No. 61/415,245 in its entirety for all purposes.

### BACKGROUND

The field of invention is generally associated with computer-based business systems designed to identify matched business interests in the furtherance of commercial transactions for goods and services.

### BRIEF DESCRIPTION OF THE DRAWINGS

FIG. 1 depicts one embodiment of a computing system used in support of the computer-implemented methods disclosed throughout the present patent application.

FIG. 2 depicts one embodiment of a web interface for a Consumer to initiate a Bid.

FIG. 3 depicts one embodiment of a block diagram depicting the basic information flow between Consumers and Providers via an intervening server computer system, during the Bid submission and response processes.

FIG. 4 depicts one embodiment of a block diagram depicting the basic information flow and functionality in the iBid System for Providers.

FIG. 5 depicts one embodiment of the basic process flow for a Consumer to initiate a Bid in the iBid System.

FIG. 6 depicts one embodiment of the iBid System central server computer system's data interactions and flows between the iBid System and a Consumer during Bid processing.

FIG. 7 depicts one embodiment of the iBid System Provider Response receipt and billing process logic.

FIG. 8 depicts one embodiment of a sample html-based electronic notification to a Provider that the Provider has been matched with a Bid from a Consumer, said notification including buttons/links to allow the Provider to submit a response (‘Accept’, ‘Counter’, or ‘Reject’, or ‘Request More Information’) to the Bid through the iBid System server.

FIG. 9 depicts one embodiment of an iBid System member Provider's Home webpage with summary information about the Provider and links to allow the Provider to manage/modify the Provider's account details and subscription terms.

FIG. 10 depicts one embodiment of an iBid System member Provider's Account Info webpage with summary information about the Provider's current account status and links to allow the Provider to manage/modify the Provider's subscription terms, payment information, etc., as well as to pull up activity reports.

FIG. 11 depicts one embodiment of an iBid System member Provider's Ratings and Reviews webpage.

FIG. 12 depicts one embodiment of an iBid System member Provider's webpage for registering a product or service to receive Bids, including setting up the price-range tolerance and the geographical location for which the goods and/or services can be provided. Notably, the geographical location setup employs a graphical map with a movable, selectable shaded/highlighted region superimposed over the map.

FIG. 13 depicts one embodiment of an iBid System member Provider's webpage for running usage reports and gather related statistics.

FIG. 14 depicts one embodiment of an iBid System member Provider's Bid History webpage, from which a Provider can view the Bids that the Provider has received, as well as the Provider's Response to each Bid. In addition some statistical summaries associated with the Provider's Bids are included.

FIG. 15 depicts one embodiment of an iBid System Administrator's webpage for running reports for sales and marketing activities.

FIG. 16 depicts one embodiment of a sample html-based electronic notification to a Consumer that a particular Provider has affirmatively responded to the Consumer's Bid (that is, has either accepted the Bid, has proposed a counter offer, or has requested more information) and wants to contact the Consumer. This embodiment also includes a Bid Summary and the contact information for the matched Provider.

FIG. 17 depicts one embodiment of an iBid System Administrator's webpage for managing iBid System Providers, Categories, Bids, Billing and Pay Scales, and the like.

FIG. 18 depicts one embodiment of an iBid System Administrator's webpage in FIG. 17, but with a pop-up window disclosing a list of matched Providers for a given Bid.

### DETAILED DESCRIPTION

### Overview

The present inventive concept is generally directed to a system and associated methods for facilitating business referrals, matching consumers with compatible providers of goods and services. In an embodiment, the system comprises a multi-tiered, web-based, client-server business-referral application through which Consumers can place bids for any product or service whatsoever. For ease of reference hereafter, the overall system is referred to the “iBid System”. In one embodiment, the iBid System consists of four interacting functional modules, offering front and back end functionality, to facilitate and monitor activity throughout the iBid System:
Consumers;
Business or Individual-Service Providers;
Administrators; and
Sales and Marketing Agents.

In many embodiments, the iBid System also has a set of functional subsystems/features, each of which is capable of functioning independently and interacting with different functional parts for different interfaces and systems. These functional modules include:
Billing system;
Messaging system via generation of e-mails, SMS messages and, and phone notifications;
Report-generation system;
Ratings of Providers of Goods & Service; and
Reviews of Providers of Goods & Service.

On such a website, Consumers access a simple web-based form through which they will describe the category and nature of the product or service they are looking for, the geographic area in which they hope to find this item, and the price they want to spend for it; that is, a “Bid” will be placed within the iBid System. This “Bid” is distributed to all Providers listed in the iBid System database (via a subscription or other form of registration) whose criteria match the conditions specified in the consumer's bid. Upon receipt of a bid matching their criteria, Providers may either “Accept,” “Counter”, “Reject”, or “Request More Information” regarding the Bid at their discretion.

While the terminology of “Accept”, Request More Information”, and “Reject” is straightforward, to “Counter” a Bid entails the presentation of a reply offer by a Provider, assuming that the bid information the Consumer proposes is nearly, but not quite, acceptable to the Provider for some reason. For example, if a software developer (Provider) receives a Consumer Bid for the creation of a website, and in this Bid the Consumer specifies a price that the software developer determines to be too low, in this case the software developer, as a service Provider, can present an offer to the Consumer which indicates the price he or she deems more appropriate. In variations, the conditions for presenting a Counter offer are not limited just to suggesting a different price, however. Rather, in some variations Providers are able to present a Counter offer or a Request for More Information to suggest changes in any aspect of a Consumer Bid that they deem necessary.

In the event that a Provider makes an ‘Affirmative Response’ to a Consumer Bid (which is defined as an ‘Accept’, ‘Request More Information’, or ‘Counter’ response only—to Reject a Bid is not considered an Affirmative Response), then the iBid System facilitates the reciprocal exchange of contact information between the parties.

The basic inventive concepts can be applied to business relationships beyond the typical consumer-service/good provider relationship. For example, the iBid System may be used in conjunction with local workforce centers and unemployment offices as a mechanism to reduce joblessness and stimulate the local economy. More specifically, by way of explanation—most every job seeker who uses the services offered by a state employment office presumably has a marketable set of skills that the job seeker is essentially trying to “sell” to a number of prospective employers. The iBid System can provide such individuals with a mechanism through which to market these skills, as well as any others they might possess, not to employers only, but to hundreds of millions of internet users either locally or worldwide.

As a more concrete example, consider, for instance, an out-of-work teacher. Such an individual likely has abilities which would allow them to offer any number of valuable paying services in addition to simply teaching. They could perform tutoring, or editing, or freelance writing services, for example. In addition, perhaps they have the ability to perform other functions such as painting, or childcare, or any number of other types of work. The iBid System provides a simple forum for such individuals to easily advertise these skills (as well as any sort of tangible merchandise they might have for sale) to a worldwide audience, and thereby become productive and gainfully self-employed members of society. Thus, the iBid System is an economic system in which people may work only for themselves, if they wish, and earn their own wealth, without any reliance on the idea that their job might finally ‘trickle down’. In an embodiment, the iBid System facilitates the ability for job seekers to tap into multiple channels to market themselves in different ways. Such a model means that one's livelihood depends on no one and nothing but oneself, one's own strength and skill, and one's own motivation and desire.

In yet more embodiments, the iBid System can be used in a number of other potential applications as well, including, but not limited to: Matching upon a number of pertinent criteria as a dating service; Sales of real estate; Sales of established companies; and Matching individuals with desired technologies, among others.

In an embodiment, the iBid System service is provided free-of-charge for Consumers; however, Providers are charged a small fee for each Bid they receive that matches their own specified criteria. In instances where a Provider chooses to Reject a matching Bid, the price for receiving that Bid will be reduced by 50%, or some other predetermined percentage. In other variations, Providers can also receive a full refund either based on the iBid System's “Invalid Bid” functionality, or through the constraints of the iBid System billing algorithm (discussed infra) when it precludes a Provider from making an affirmative response.

In another embodiment, Providers are charged different levels of subscriber fees, which then translates into how frequently a given Provider may be contacted by the iBid System with qualified Bids for goods and services. In another variation, Providers can also choose to pay a premium in order to reduce their level of competition for any Bid.

In still more embodiments, Consumers are charged a small membership fee to participate in the iBid System in order to realize optimum deals for desired goods and services, just as customers of large warehouse stores such as Cosco® and Sam's Club® charge their customers a membership/access fee.

In even more embodiments, the iBid System services can be provided to Consumers by sales representatives/agents, who offer Consumers the opportunity to place an order/Bid with the agents, who in turn interface with the iBid System to place and manage the orders, thus eliminating the need for a Consumer to directly access a web-based computer interface in order to enjoy the benefits of the iBid System.

### Terminology (General)

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

If the specification or claim refers to “a” or “an” element, this does not mean there is only one of the described elements.

The term “couple” or “coupled”, as used in this specification and the appended claims, refers to either an indirect or a direct connection between the identified elements, components, or objects. Often, the manner of the coupling will be related specifically to the manner in which the two coupled elements interact.

The term “removable”, “removably coupled”, “readily removable”, “readily detachable”, “detachably coupled”, and similar terms, as used in this patent application specification (including the claims and drawings), refer to structures that can be uncoupled from an adjoining structure with relative ease (i.e., non-destructively, and without a complicated or time-consuming process) and that can also be readily reattached or coupled to the previously adjoining structure.

However, the term “fixedly, but detachably, coupled”, as used in this patent application specification (including the claims and drawings), is meant to indicate a structurally sound, but not permanent, coupling between components. Such couplings often involve the use of hardware fasteners that must be assembled and disassembled to couple or decouple components, respectively.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments in this specification and the appended claims, and are not necessarily intended to be construed as limiting.

As applicable, the terms “about” or “generally”, as used herein in the specification and appended claims, and unless otherwise indicated, means a margin of +−20%. Also, as applicable, the term “substantially” as used herein in the specification and appended claims, unless otherwise indicated, means a margin of +−10%. It is to be appreciated that not all uses of the above terms are quantifiable such that the referenced ranges can be applied.

If within the specification or its appended claims it is said that an element “X” is coupled to or with element “Y,” element X may be directly coupled to element Y or be indirectly coupled through, for example, element “Z”. When the specification or claims state that a component, feature, structure, process, or characteristic X “causes” a component, feature, structure, process, or characteristic Y, it means that “X” is at least a partial cause of “Y” but that there may also be at least one other component, feature, structure, process, or characteristic that assists in causing “Y.” If the specification indicates that a component, feature, structure, process, or characteristic “may”, “might”, or “could” be included, that particular component, feature, structure, process, or characteristic is not required to be included.

The term “Bid”, “offer”, and similar terms, as used in this patent application specification (including the claims and drawings), in the context of a submission to the iBid System from a Consumer or a first user, refer to an initiation of a proposal for some sort of business transaction, often a proposed monetary sale price for goods and/or services from a Consumer. However, in some embodiments, other types of proposals and consideration are possible. For example, a job seeker with a set of skills might offer (Bid) to provide his or her skill set for an employment position in a certain field (Category) and geographical location in the hope that the iBid System can identify a match with a prospective employer (Provider). In even more embodiments, Bids can include bartering types of offers, offers to trade, and the like.

In addition, in other embodiments, individuals can register as Providers and begin accepting bids for any product or service they might be able to offer. Additional embodiments allow for larger companies/contractors to use the iBid System service to find smaller suppliers/subcontractors.

### Computer-System Hardware In Support of the iBid System And Methods

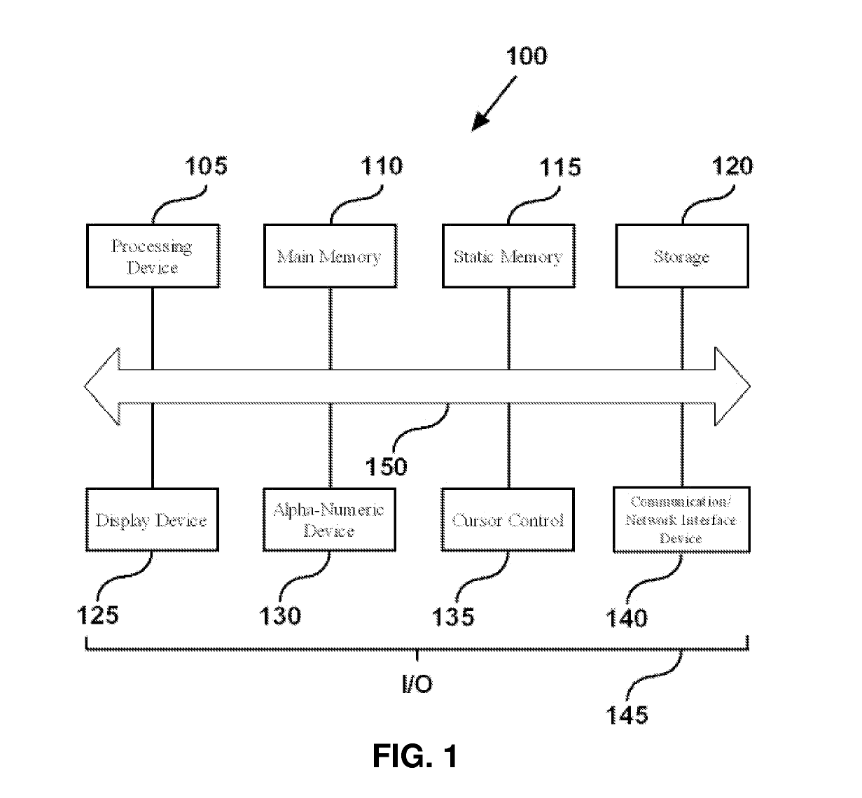

A computer system (and similar terms) refers to a computer system or machine, and may include and function in a server or client computer system capacity in, for example, a server-client environment. Refer to FIG. 1 for one embodiment of such a system used to support the inventive concepts disclosed herein. A computer system 100 may be a personal computer (PC), a Personal Digital Assistant (PDA), a computer pad or tablet, a smart mobile phone, a web server, or any data processing machine capable of storing and executing instructions to perform various tasks mentioned throughout this specification, including the claims and drawings. Although the computer system 100 is shown as a single machine, it is contemplated that the term “machine”, as referred to in this patent application, may include any number of machines in communication with each other or other remote machines. A computer system 100 may be in communication with other machines over a network (e.g., local area network (LAN), wide area network (WAN), metropolitan area network (MAN), intranet, the Internet, etc.) as connected or networked through a communication/network interface device 140 (e.g., network interface card, modem, other devices such as to connect to Ethernet, token ring, etc.). Further, a computer system 100 may be accessed or communicated with using various other input/output (I/O) devices 145, such as an input device, such as an alpha-numeric device 130 (e.g., keyboard) and/or a cursor control device 135 (e.g., mouse), and a display device 125 (e.g., a video display device, such as a liquid crystal display (LCD), a cathode ray tube (CRT), etc.) and other similar devices, such as speakers, etc., connected through a graphics port or chipset.

A computer system 100 also includes a processing device 105. Processing device 105 represents one or more general-purpose processing devices (such as a microprocessor, central processing unit, etc.) and more particularly, the processing device may be complex instruction set computing (CISC) microprocessor, reduced instruction set computer (RISC) microprocessor, very long instruction word (VLIW) microprocessor, or a processing device implementing other instruction sets or a combination of instruction sets. Processing device 105 may also be one or more special-purpose processing devices (e.g., application specific integrated circuit (ASIC), a field programmable gate array (FPGA), a digital signal processor (DSP), network processor, etc.). In one embodiment, processing device 105 is configured to execute the processing logic for performing the operations and methods discussed herein and as performed by the iBid System.

A computer system 100 further includes a main memory 110 (e.g., read-only memory (ROM), flash memory, random access memory (RAM), dynamic RAM (DRAM), synchronous DRAM (SDRAM), etc.), a static memory 115 (e.g., flash memory, static random access memory (SRAM), etc.), and other storage 120 (e.g., a data storage device or a magnetic disk or optical disc in the form of a drive unit, which may include fixed or removable machine-accessible or computer-readable storage medium), which communicate with each other via a bus 150. Storage 120 may include a machine-accessible storage medium that may then be used to store one or more sets of iBid System instructions (e.g., matching mechanism instructions, billing process, etc.). The iBid System instructions may be transmitted or received over a network via the network interface device 140. The iBid System instructions described herein may also reside, completely or at least partially, within the main memory 110 and/or within the processing device 105 (e.g., matching mechanism processing logic) during execution thereof by the computer system 100, the main memory 110 and the processing device 105 also constituting machine-readable storage media. Further, in one embodiment, the various processes for the iBid System (e.g., matching mechanism, billing, etc.) may be employed (entirely) on a single machine, such as computer system 100, or (partially or entirely) on different computer systems.

Machine-accessible storage medium 120 (also referred to as “machine-readable storage media”, “computer-readable medium” and similar terms), while often described as a single medium, includes a single medium or multiple media (e.g., a centralized or distributed database, and/or associated caches and servers) that store the one or more sets of instructions. In addition, references to machine-accessible storage medium include any medium that is capable of storing, encoding, or carrying a set of instruction for execution by the machine and that cause the machine to perform any one or more of the methodologies of the present inventive concepts. Accordingly, machine-accessible storage medium shall be taken to include, but not be limited to, solid-state memories, optical media, and magnetic media.

As aforementioned, in one embodiment, the various iBid system processes and instructions are represented as and includes modules, components, and other features, as described throughout this patent application. In an embodiment, iBid System instructions can be implemented as discrete hardware components or integrated in the functionality of hardware components such as Application-Specific Integrated Circuit (ASIC), Field-Programmable Gate Array (FPGA), Digital Signal Processor (DSP), etc., or as software or as firmware or functional circuitry.

Throughout the foregoing computer-system (and related components) description, for the purposes of explanation, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions described herein are presented in terms of algorithms and symbolic representations of operations on data bits within a computer memory. An algorithm is here, and generally, conceived to be a self-consistent sequence of processes or steps leading to a desired result, and these processes or steps are those requiring physical manipulations of physical quantities manifesting as electrical or magnetic signals (e.g., bits, values, elements, symbols, characters, terms, numbers, etc.) capable of being stored, transferred, combined, compared, and otherwise manipulated. Further, terms (such as “configure”, “determine”, “acquire”, etc.) may be associated with various physical quantities and refer to action or processes or steps of processing logic of a processing device, such as the processing device 105, of a data processing device, such as the computer system 100. It is contemplated that the apparatus may be specially constructed for the required purposes, or it may comprise a general-purpose computer selectively activated or reconfigured by a computer program stored in the computer. Such a computer program may be stored in a machine-readable storage medium, such as, but not limited to, any type of disk including floppy disks, optical disks, magnetic-optical disks, ROMs, compact disk ROMs (CD-ROMs), RAMs, erasable programmable ROMs (EPROMs), electrically EPROMs (EEPROMs), magnetic or optical cards, or any type of media suitable for storing electronic instructions, each coupled to a computer system bus. However, it is further contemplated that methods (e.g., algorithms, processes, steps, etc.) and displays presented herein are not inherently related to any particular computer system or apparatus. Various general purpose systems may be used with programs in accordance with the teachings herein, or it may prove convenient to construct more specialized apparatus to perform the required method steps. Moreover, the present invention is not described with reference to any particular programming language or operating system or software platform. For example, it is appreciated that a variety of programming languages may be used to implement the teachings of the invention as described herein.

As aforementioned, embodiments of the present invention may be provided as a computer program product, or software, that may include a machine-readable storage medium having stored thereon instructions, which may be used to program a computer system (or other electronic devices) to perform a process according to the present invention. A machine-readable storage medium includes any mechanism for storing or transmitting information in a form readable by a machine (e.g., computer system 100). For example, a machine-readable (e.g., computer-readable) medium includes a machine (e.g., a computer) readable storage medium (e.g., ROM, RAM, magnetic disk storage media, optical storage media, flash memory devices, etc.), a machine (e.g., computer) readable transmission medium (non-propagating electrical, optical, or acoustical signals), etc.

Many of the computer-implemented methods discussed herein are described in their most basic form, but processes can be added to or deleted from any of the methods and information can be added or subtracted from any of the described messages without departing from the basic scope of the present inventive concepts. It will be apparent to those skilled in the art that many further modifications and adaptations can be made. The particular embodiments are not provided to limit the inventive concepts, but to illustrate them. The scope of the embodiments of the present inventive concepts is not to be determined by the specific examples provided above but only by the appended claims.

### iBid System Core Functionality—Bid-Processing And Matching

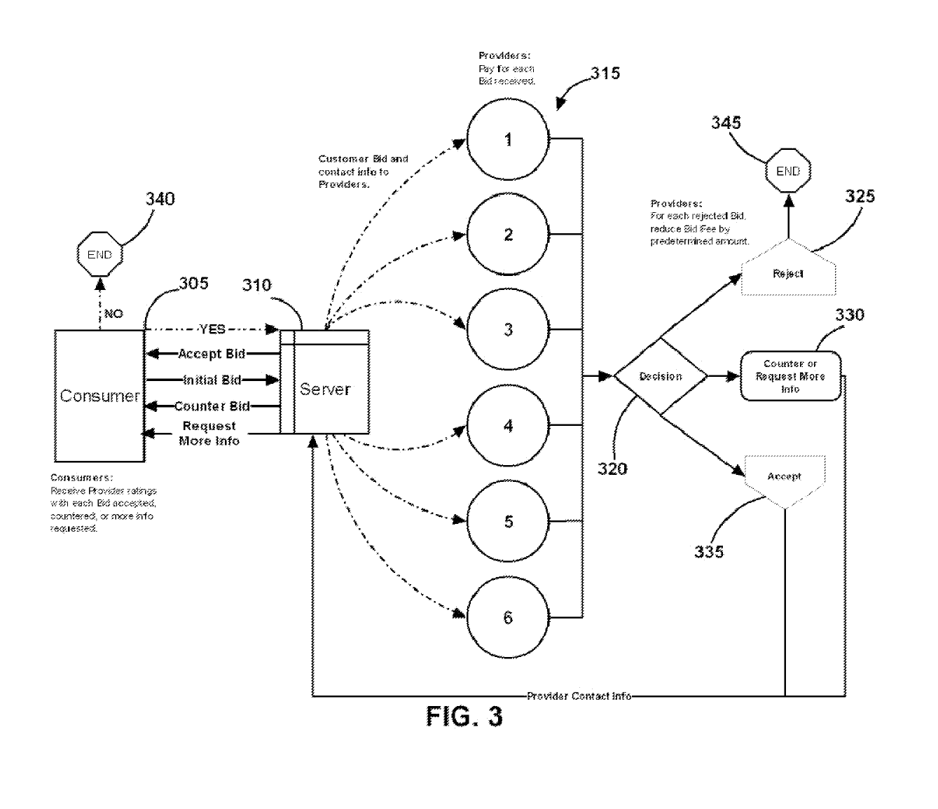

In some embodiments, the iBid System stores data for all service Providers. Queries are made against this database by Consumers, and matches are based on three specific criteria: (1) Goods/Service Category, (2) Location (either within the associated local market, a user-specified expanded or added region, or globally), and (3) Price. An embodiment of the basic processes and relationships associated with Consumer Bid initiation, iBid System processing of a submitted Bid, Provider Response and management of received matched Bids, and iBid System processing of Provider Responses is depicted in FIGS. 3-7.

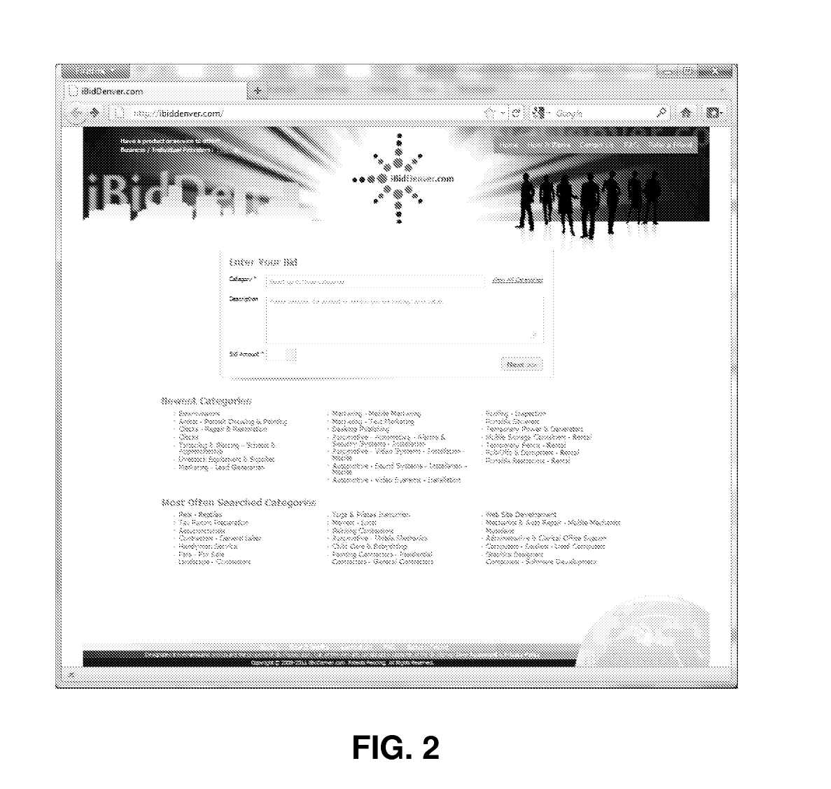

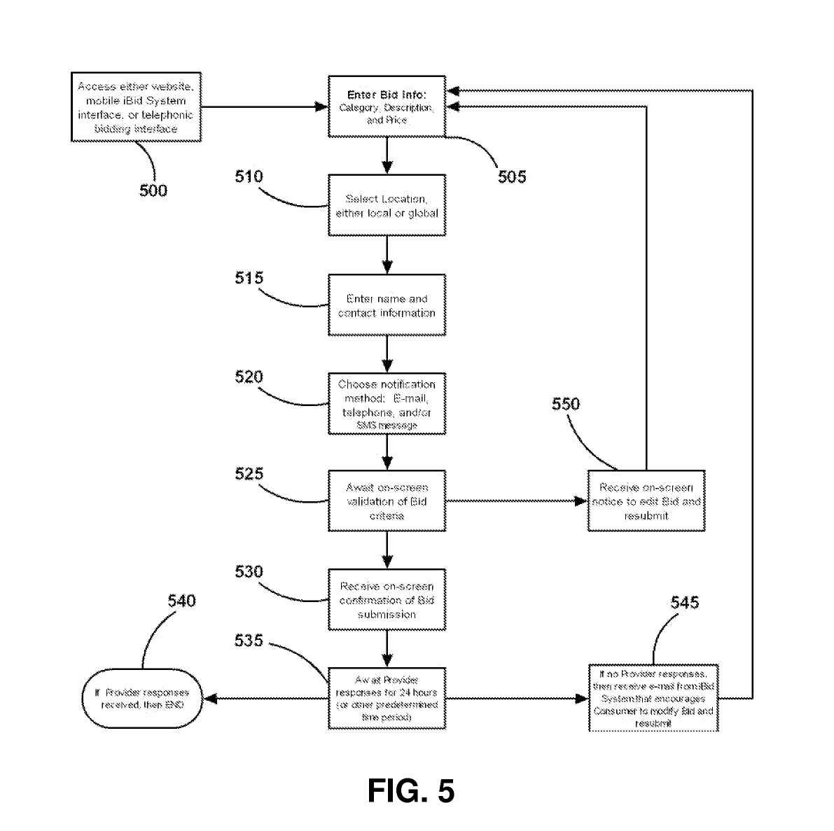

Refer to FIG. 5, which depicts one embodiment of the general process of a Consumer's Bid initiation. In variations, when registering Provider products or services, Providers are able to select as many Categories as they wish in order to fully describe items that they offer, which provides a form of multi-channel marketing. Similarly, Consumers are able to select up to a predetermined number of Categories when submitting a Bid. (See FIG. 2 for one embodiment of a Bid-initiating web interface.)

From the Consumer's web interface with the iBid System, in a variation, a self-populating drop-down menu is provided which allows for multiple Category selections. All products and services currently offered by Providers are organized by the list of Categories and subcategories. An exemplary comprehensive list of Categories and Subcategories for one embodiment is provided in U.S. Patent Application No. 61/415,245, from which the present patent application claims benefit from. An excerpt from that list, for demonstration purposes only is as follows:

| | |
|---|---|
| 1 | Accountants |
| 2 | Certified Public |
| 3 | Acupuncturists |
| 4 | Advertising Agencies |
| 5 | Direct Mail |
| 6 | Magazine |
| 7 | Newspaper |
| 8 | Promotional Products |
| 9 | Shoppers Guide |
| 10 | Air Conditioning |
| 11 | Contractors |
| 12 | Air Duct Cleaning |
| 13 | Installation |
| 14 | Repair |
| 15 | Aircraft |
| 16 | Charter |
| 17 | Rent & Lease |
| . . . | |

In a variation, Consumers can also enter in free-form text to be submitted with the Bid to more specifically define/describe what the Consumer is looking for. In some embodiments, natural-language processing is employed in the back-end processing to probabilistically determine the best Category matches to these types of textual entries.

In another variation, Consumers enter a proposed price or other consideration for the good or service being sought.

However, in another embodiment, a Consumer can request a quote from Providers, rather than naming their own price. In such an embodiment, Providers have the option to accept these sorts of Bids or not, and the price for receiving any such bid is based upon a three-tiered scale (Low, Mid-Range, High) related to the iBid System Administrators' estimation of the average value of items within each category. For example, items such as pets, or compact discs, or tennis shoes typically fall at the low-end of the scale (and Providers are charged a small fee for receiving Bids from Consumers requesting a quote on these items), while items and services such as houses, cars, or large-scale home remodeling fall at the high-end (and Providers will be charged a proportionally higher amount).

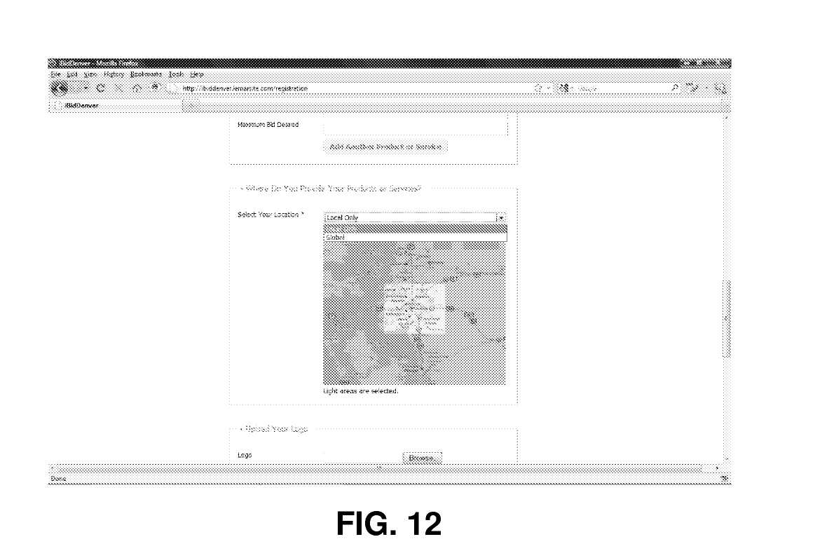

In other variations, regarding “Location,” matching for a local query is performed by including a map of the city, divided into substantially equal zones. In one exemplary embodiment, for iBidDenver.com, nine zones are assigned to the Metropolitan Denver Area: Three zones to the north, three zones in the central areas, and three zones in the south, with each zone virtually ‘numbered’—1 through 9—so that any search that is done by location can be within these discrete regions. In one variation, both the webpage for a Provider to assign a geographical location to the Provider's goods and/or services and the webpage for a Consumer to select a local region for a search/Bid involve a movable highlighting box across a local map, the box corresponding in size to one of the zones discussed supra, wherein the position of the box superimposed over the map determines the preferred search area that a user may select. (See, e.g., FIG. 12.) Providers and Consumers should be able to select as few or as many of these regions as they wish, and be matched accordingly. It will be appreciated by those skilled in the art that the size of the map and the size and number of zones would be adjusted as appropriate for a given geographical area.

Also regarding “Location,” in a variation, Consumers have the option to selectively search/Bid locally (as discussed above), or globally. In many embodiments, the local search is the default selection for a Consumer. The global search, by contrast, appears as an option alongside (and in place of) the local search, and includes the entire iBid System database worldwide.

In still more variations, Consumers enter their contact information and preferred notification method. In another embodiment, Consumers are be able to create an account and store their preferred contact information so that they are able to submit bids more rapidly (by only entering a description and location criteria for the desired product or service, as described, supra,) and also log into their account in order to review and print reports summarizing their bidding history on the site, etc.

In an embodiment, Consumers are only allowed to submit a particular Bid once every 24 hours. Thus, the iBid System must maintain a record of all previous Consumer Bids and their timestamps, and verify all new Bids against all those submitted within this timeframe by matching against the previous Bids' Categories, Locations, Price, and Consumer e-mail addresses. In the event that a Consumer attempts to submit an identical Bid within a predetermined time period (e.g., 24 hours), the iBid System will reject the second Bid and display an appropriate message to alert the Consumer of the limitation of one Bid per system-specified time-period limit.

In addition, in another embodiment, Consumer Bids expire after a predetermined time period (for example, 24 hours) after being submitted. Thus, when this time has passed, Providers should no longer receive Consumer Contact information upon submitting an Affirmative Response (‘Accept’, ‘Counter’, or ‘Request More Information’ only) to that particular Bid. Instead, Providers who attempt to submit an Affirmative Response after the predetermined time period receive an electronic communication that informs the Provider that the Bid is no longer available, and encourages the Provider to reply more quickly in order to improve the Provider's chances of winning matching Bids in the future. For billing purposes, in a variation, all such late Provider responses (or non-responses) are construed as ‘Reject’ for billing and all other purposes.

In another variation, during the Consumer Bid process, if a Consumer feels that there is not a listed Category of goods or services that adequately meets the needs of the Consumer, then the Consumer has the opportunity to submit a suggested new Category for use and display within the iBid System. Typically, such functionality is in the form of an e-mail to the website Administrator.

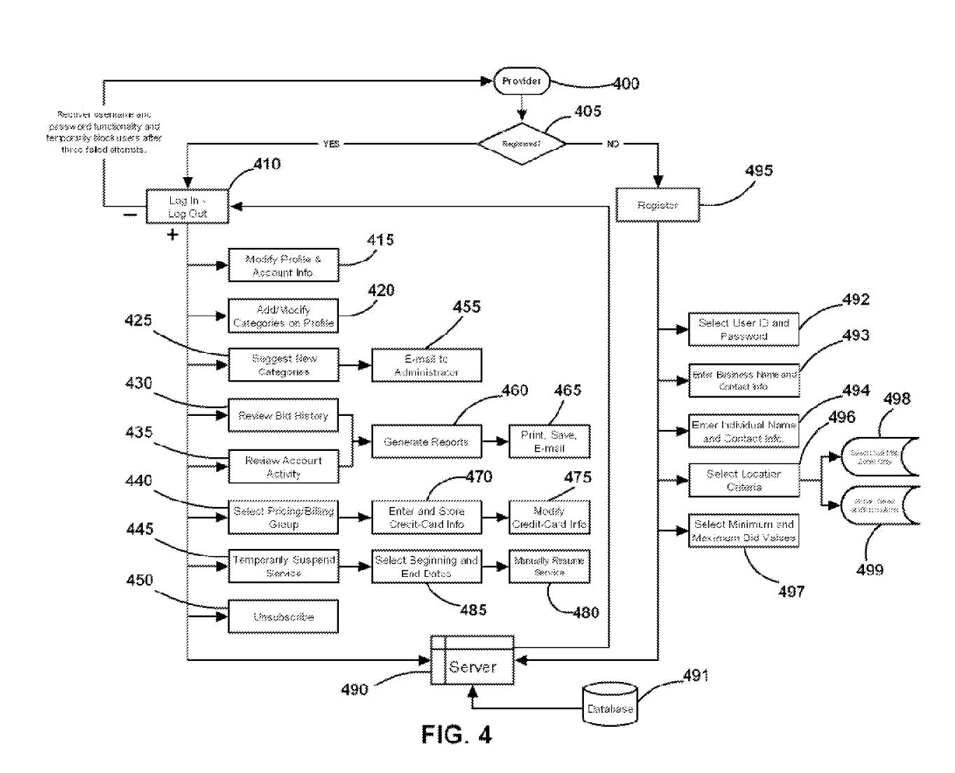

In another variation, regarding “Price,” business and individual Providers are be able to specify a range of prices to describe the products or services they supply. (See FIG. 4.) In many variations, each product or service (or more appropriately, each Category the Provider selects to describe their products or services) has its own price range, and the amount the Consumer enters when initiating a Bid is compared against/matched to this range.

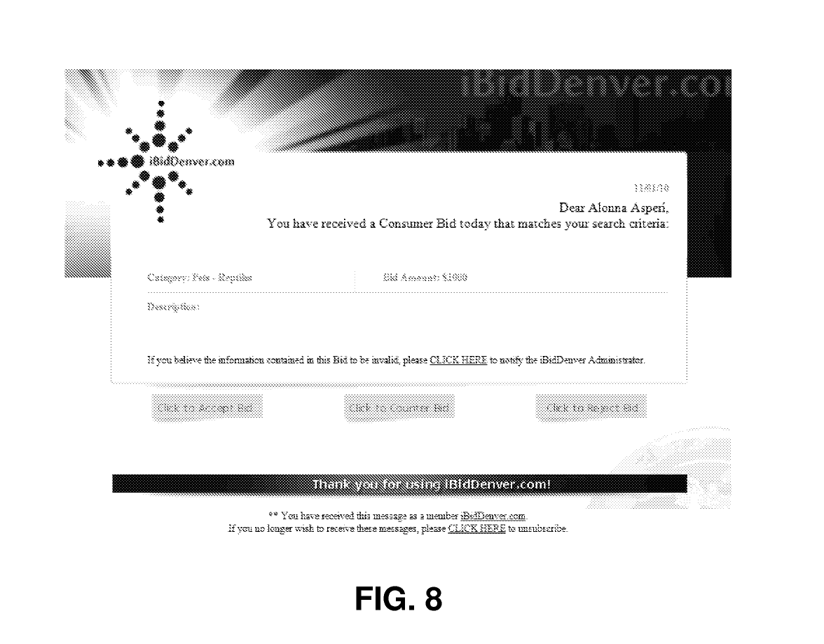

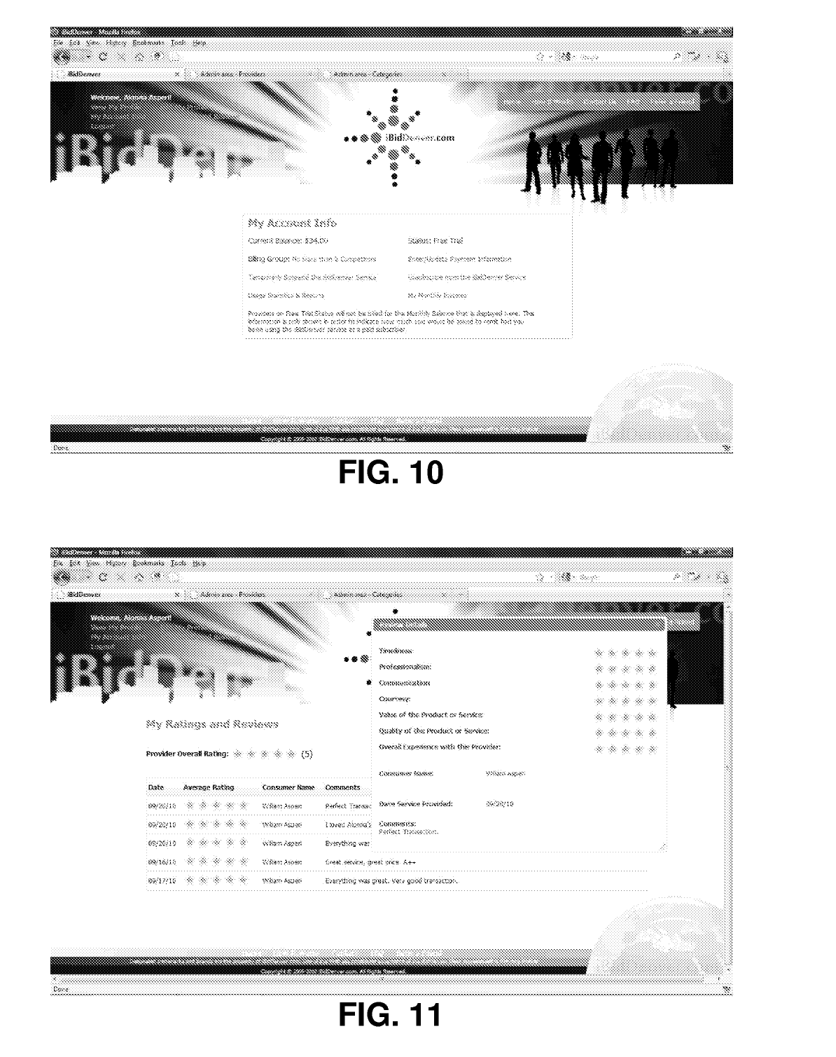

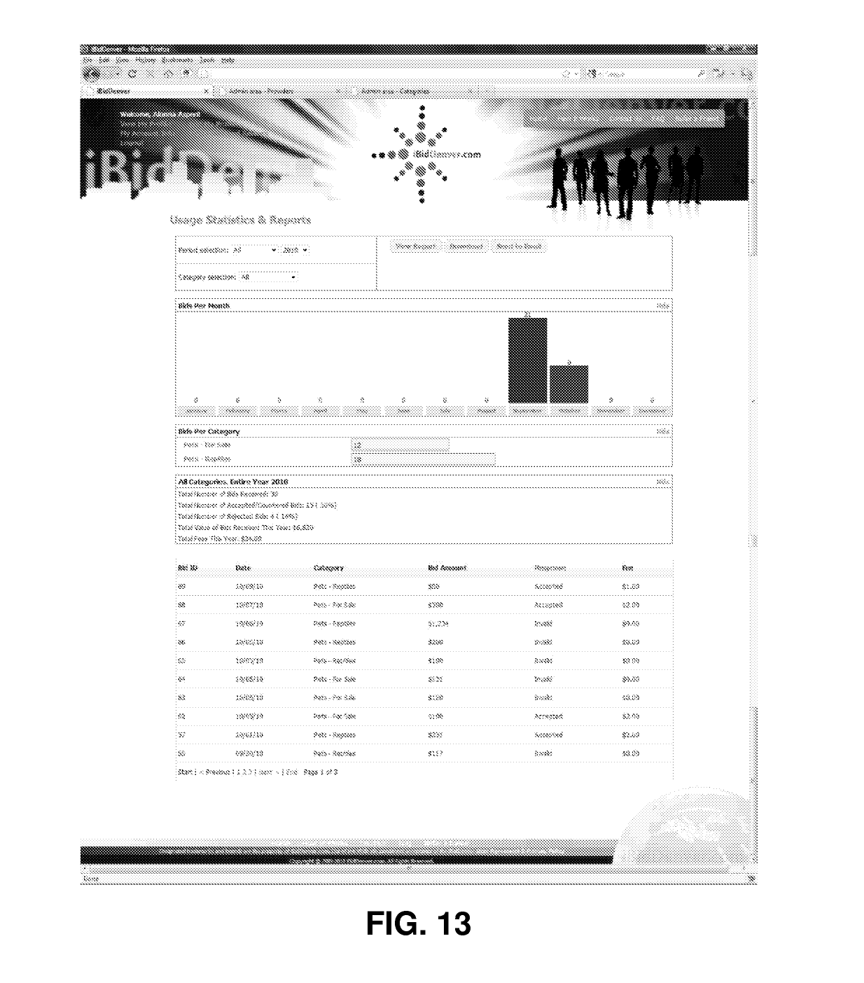

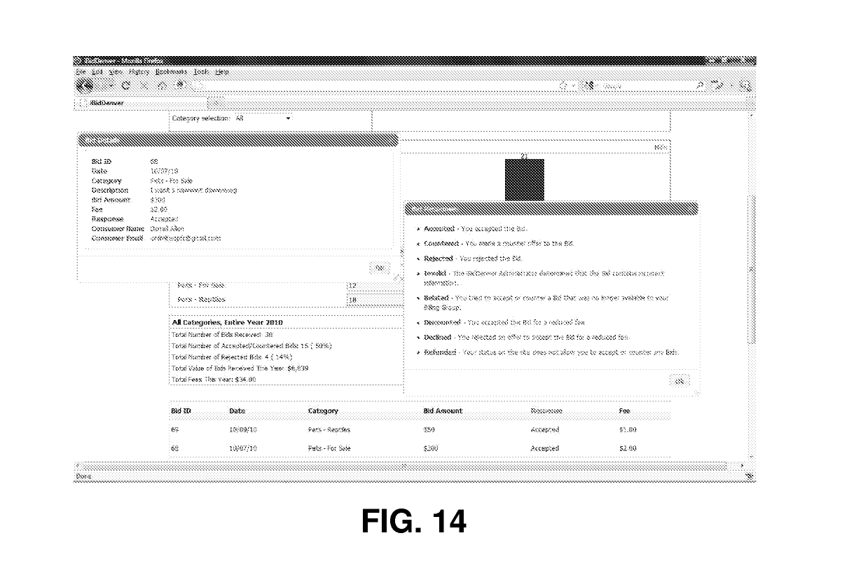

In an embodiment, upon registering their products or services within the iBid System, Providers are immediately matched against all active Bids (those which have been submitted within the past 24 hours or some other programmed predetermined time period), and for any matches that are found, all of the proper e-mail and/or SMS notifications are sent to the Provider (see, e.g., FIG. 8). Registered Providers also have the ability to manage their accounts to access and update account information, billing information, offered goods and services information, username and password information, and the like. See, e.g., FIGS. 4 and 9-14. Similarly, in some variations, the process happens for already existing Providers who modify their Category/Location/Price criteria and consequently match to still-active Bids.

In another variation, if a Provider feels that there is not a listed Category of goods or services that adequately meets the needs of Consumers and/or the Provider, then the Provider has the opportunity to submit a suggested new Category for use and display within the iBid System. Typically, such functionality is in the form of an e-mail to the website Administrator.

In one embodiment, a simple overview of the logic underlying the iBid System matching functionality is as follows:

| A) | Category | |
|---|---|---|
| | IF ANY Consumer Category = ANY Provider Category = TRUE, | |
| | then Go to B) | |
| | IF ANY Consumer Category = ANY Provider Category = FALSE, | |
| | then END | |
| B) | Location | |
| | IF ANY Consumer Location = ANY Provider Location = TRUE, | |
| | then Go to C) | |
| | IF ANY Consumer Location = ANY Provider Location = FALSE, | |
| | then END | |
| | Note: | When a Consumer runs a GLOBAL search, their Bid is |
| | | matched for location against all local Providers in their |
| | | categories and price range, as well as all Providers in |
| | | other iBid markets who have specified “GLOBAL” in |
| | | their Provider profiles as their location criterion. This |
| | | kind of search omits/filters-out Providers in other markets |
| | | who have specified a local location in their profile. |

| | |
|---|---|
| C) | Price |
| | IF Consumer Price IS BETWEEN Provider MIN Price and Provider |
| | MAX Price = TRUE, then Go to D) |
| | IF Consumer Price IS BETWEEN Provider MIN Price and Provider |
| | MAX Price = FALSE, then END |
| D) | E-mailing/Provider Notification Functionality |
| | IF ALL A, B, and C = TRUE, then Initiate E-mailing/Notification |
| | Functionality |
| | IF ANY A, B, or C = FALSE, then END |

In a variation, the above matching algorithm can be modified so that if there are a large number of matched providers, the iBid System randomly selects a block of the matching businesses within the Consumer-chosen Category and only sends the Bid to the Providers in that that block. For example, if there are 80 matches, the iBid System might send the Bid to only 10 Providers out of that 80. Moreover, in a further variation, when another bid is placed to the same Category, the iBid System will select the next block of 10, and distribute the bid to the Providers in this newly selected block, and this block-selection process continues until all Providers in the Category have received a bid. In yet another option related to this variation, Providers have the opportunity to pay a premium in exchange for programmatically increasing their odds (e.g., weighting a given Provider, increasing the frequency of occurrence of a given Provider as the selection process iterates through all of the available Providers, etc.) of being selected in a ‘random’ block of Providers in order to receive a higher number of Bids over time.

In an embodiment, the iBid System manages Bids and automatically sends out appropriate notifications to Consumers and Providers, as well as sets the billing protocol for Providers based in part on Bid status. In a variation, six types of Bid status are defined for Bids, summarized as follows:
Unmatched—Any Bid that does not match any Providers in the database. An Unmatched Bid can change to ‘Pending’ status if a new Provider's criteria match within a programmatically predetermined time; e.g., 24 hours.
Pending—Any Bid that has been matched to at least one Provider, is less than 24 hours old, and has not yet received any response (‘Accept’, ‘Request More Information’, ‘Counter’, or ‘Reject’) from a Provider.
Active—Any Bid that has been matched to at least one Provider, is less than 24 hours old, and has received at least one response (‘Accept’, ‘Request More Information’, ‘Counter’, or ‘Reject’) from a Provider.
Invalid—Any Bid that has been matched to at least one Provider, and has been marked as Invalid by a programmatically predetermined percentage (e.g., at least 50%) of the Providers who have received it. Providers are not billed for any Invalid Bids. Providers are provided with a link from their account-management webpage and/or in the Bid-notifications e-mail through which a Provider can notify the iBid System Administrator of an invalid Bid and the reasons why the Provider considers the Bid invalid. In a variation, this process for flagging an Invalid Bid occurs when either 50% of the Providers who have received the Bid indicate that it is invalid, or a minimum of 50% of the Providers who make an affirmative response (‘Accept’, ‘Counter’, or “Request More Information’).

In another variation, when a predetermined percentage of Providers receiving a given Bid indicate that the Bid is invalid, then the iBid System automatically marks the Bid as such in the administrative interface, and iBid System Administrator is automatically notified to verify that the bid in question is, in fact, invalid.

In one variation, all Invalid Bids remain in the matching Providers' history, marked as “Invalid” under the ‘Type’ field on the ‘Monthly Bid History’ and ‘Bids Per Category’ reports. In addition, the ‘Tee’ field on these reports will indicate $0 for these invalid Bids.
Expired—Any Bid that has been matched to at least one Provider but has not received any Affirmative Responses within a predetermined time period; e.g., 24 hours.
Closed—Any bid that has been matched to at least one Provider, has received at least one Affirmative Response, and is more than some predetermined time period (e.g., 24 hours old); or a Bid which has received enough Affirmative Responses under the Billing Algorithm that no more can be Accepted.

In another embodiment, the iBid System provides a plurality of possible predetermined responses that a Provider can make in response to any Bid. A variation of this is summarized as follows:
1. Accepted—When a Provider Accepts a Bid when it is received.
2. Countered—When a Provider Counters a Bid when it is received.
3. Rejected—When a Provider Rejects a Bid, or fails to reply to it within some predetermined period of time (e.g., 24 hours) after receipt.
4. Invalid—A Bid marked as invalid by a predetermined number of Providers; e.g., either 50% of the Providers who have received the Bid must indicate that it is invalid or a minimum of 50% of the Providers who make an affirmative response (‘Accept’, ‘Request More Information’, ‘Counter’, or “Request More Information’), and which is later verified by the iBid System Administrator.
5. Belated—When a Provider tries to ‘Accept’, ‘Request More Information’, or Counter a Bid that is no longer available due to the limitations of the Billing Algorithm. (For example, if a Provider from Billing Group B attempts to Accept a Bid that has already been allocated by the iBid System algorithm to Billing Group A, and Group A has already received the maximum number of Providers allowed and is therefore closed.)
6. Discounted—When a Provider attempts to accept a Bid that belongs to a billing group that is lower than the one to which he belongs (as described in #1, above), and chooses to accept the offer to compete for the Bid at higher level of competition and a lower price.
7. Declined—When a Provider attempts to accept a Bid that belongs to a billing group that is lower than the one to which he belongs (as described in #1, above), and chooses to Decline the offer to compete for the Bid at a higher level of competition and lower price.
8. Refunded—Every Bid sent to a Provider who is on either ‘Pending’ or ‘Past Due’ status.

When these Providers make a payment so that ‘Pending’ or ‘Past Due’ Provider status changes to ‘Active,’ such providers are sent Consumer contact e-mails for all viable (e.g., less than 24 hours old) ‘Refunded’ Bids to which they have made any Affirmative Response (‘Accept’, ‘Counter’, or ‘Request More Information’ only), and the Response column and Fee on their Provider Reports pages are changed to reflect their choice.

### iBid System Core Functionality—Back-End Processing To Orchestrate Electronic Notifications

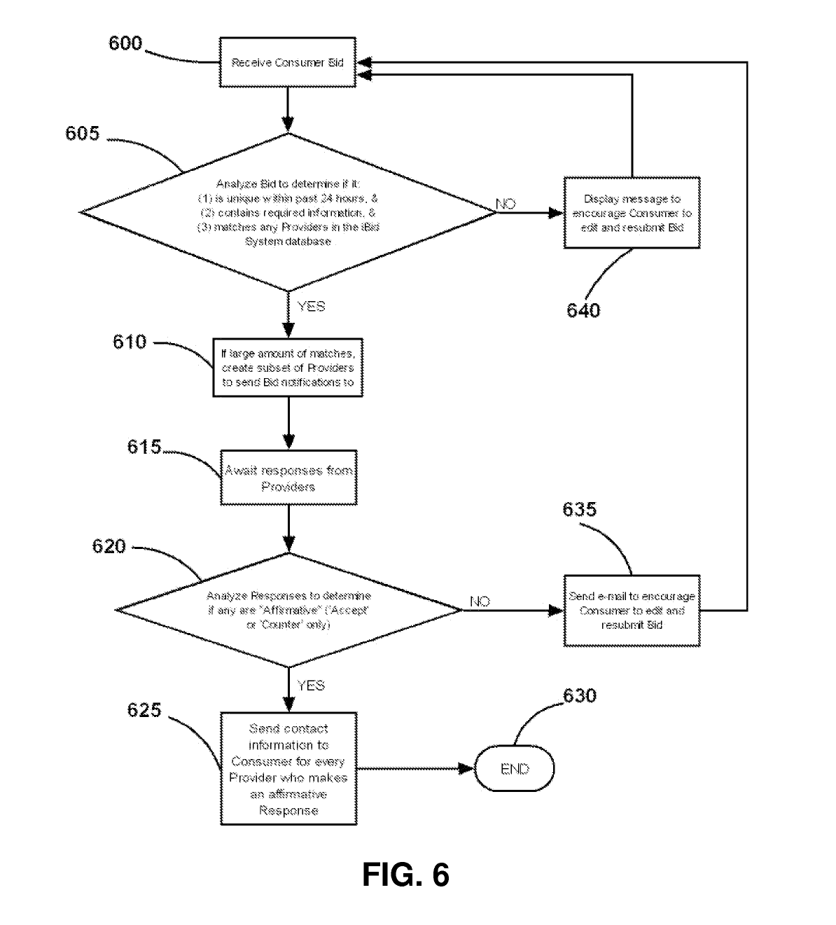

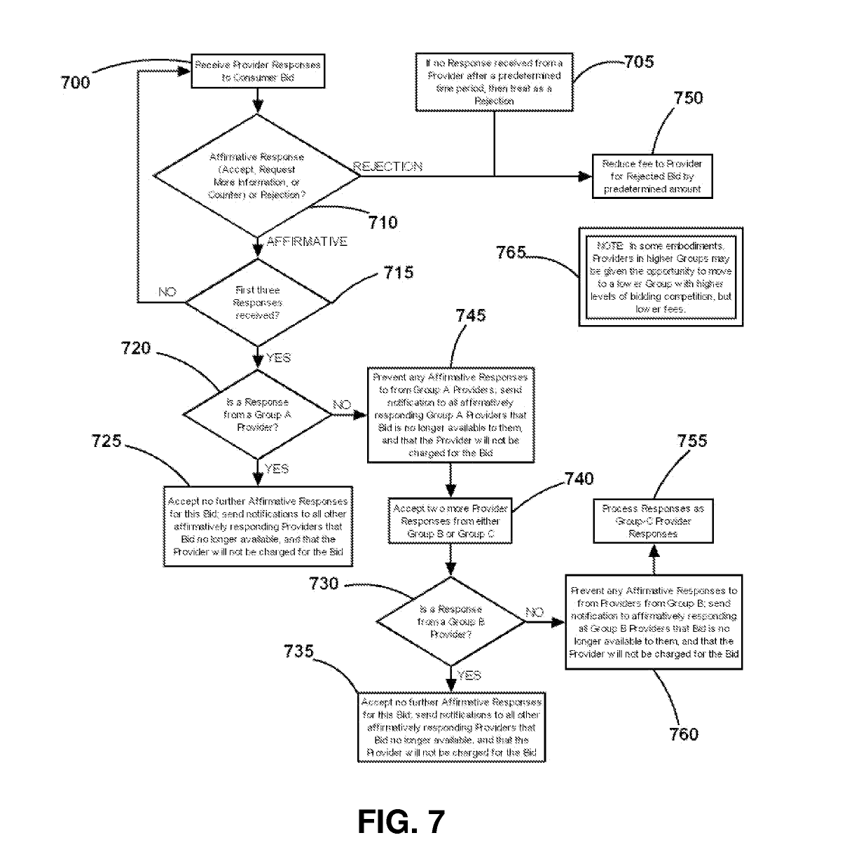

Refer to FIGS. 6, 7, which among other things, depict an embodiment of the iBid System processing of automatic electronic notifications of Consumers and Providers. In various embodiments, there are a number of situations in which the website should be programmed to automatically generate electronic notifications; e.g., e-mails and/or Short Message Service (SMS) for the Providers and Consumers who use the service. In a variation, automated telephonic voice and/or fax notifications are provided. Similarly, in some embodiments, Providers have the ability to respond to Bids via telephonic communications, including keypad and/or voice-recognition capabilities Likewise, in a variation, Consumers have the ability to place a Bid via telephonic communications, including keypad and/or voice-recognition capabilities. The most important of these notifications is when a match is found between a Consumer Bid and a Provider's Category, Location, and Price (or price-range tolerance). In this case, there is back-end programming that sends the Consumer's Bid to all matching Providers via an e-mail (preferably, but not necessarily html-based) and/or an SMS alert that a match has been found (at the Providers' discretion). In some variations, Providers are notified of matching Bids via automated telephone calls to Providers' on-record contact telephone number.

In variations, these e-mail messages should self-populate particular information from the database related to the Bid including, for example, the Consumer's name, e-mail address, the Category they searched, the description they provide regarding the product or service they are looking for, and the amount of their Bid, etc. In the case of an html-based e-mail, it also includes the functionality required for Providers to ‘Accept’, ‘Request More Information’, ‘Counter’, or ‘Reject’ the Bid when they receive it, directly from the message, without requiring the Provider to log in or return to the website. Obviously, if the electronic communication is such that there is no such embedded functionality, then the Provider must access the Provider's account via the website in order to respond to the bid. In addition, in many embodiments, the iBid System provides a Bid-management web interface, accessible from the Provider's account-management webpage, and at which a Provider can respond to received Bids. If a plain-text e-mail notification is sent, in an embodiment, it includes the same functionality as the HTML messages, except that the links required to make a response are not displayed as buttons but rather as strings of code that can be implemented in a web browser. See FIG. 8, each depicting one embodiment of an html-based Provider Bid-Notification message, with built-in response functionality.) In many typical variations, e-mail notification is the default setting within the iBid System, though alternate or additional notification means can be opted for.

Similarly, in variations, any SMS message sent to a Provider to alert them that they have received a Bid should allow the option to Accept or Reject the Bid (but not the option to ‘Counter’ or ‘Request More Information’), directly from the message. Because of the 140-character size limitations for SMS messaging, a “Counter” offer to the Consumer may require more information than can be sent via one SMS message. Nevertheless, in many variations, SMS message notification pertaining to the receipt of any Consumer Bid is available for all business Providers. In an embodiment, the SMS messaging system includes the ability for

Providers to “Accept” or “Reject” any Bid via a reply SMS message to the iBid System, using “1” for “Accept,” and “2” for “Reject”, or other similarly short character responses. In other variations, if a Provider chooses to Accept a Consumer Bid from an SMS message, the Provider then receives a follow-up SMS (and/or e-mail) that includes the Consumer's contact information to facilitate follow-up by the Provider.

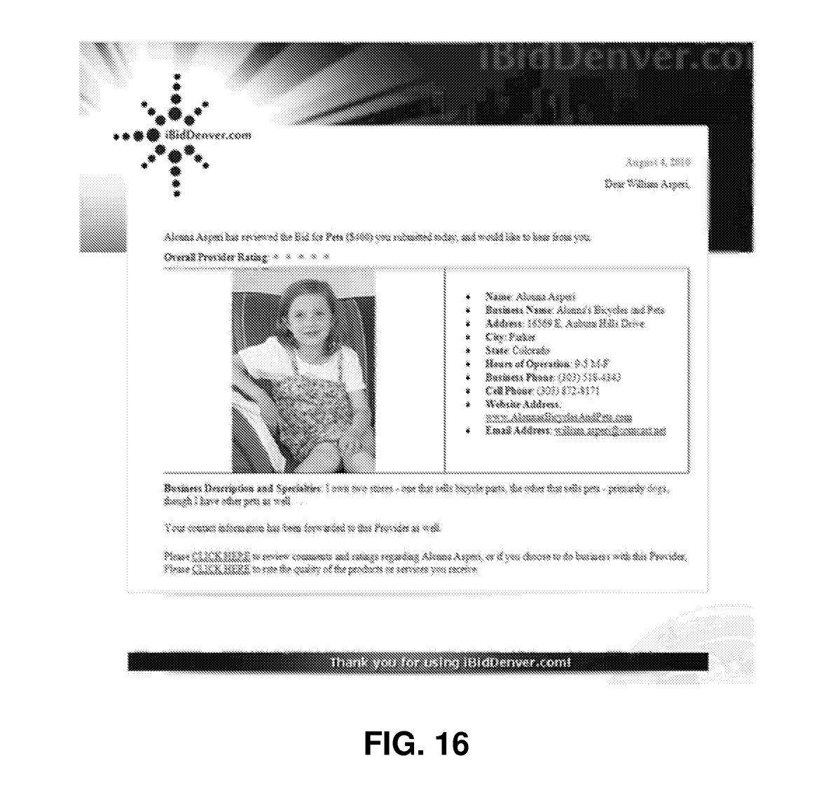

In another embodiment, in addition to automated e-mail communications with Consumers when a Bid acquires a status of ‘Accepted’, ‘Request More Information’, or ‘Countered’ (see FIG. 16, for an embodiment of such an e-mail communication), SMS messaging is also available for Consumers when their Bid is either Accepted or Countered by a Provider. In the case of a counter proposal from a Provider, the SMS message to the Consumer requires the Consumer to log into their iBid System account in order to view the details of the counter proposal. In either case, the Consumer is provided with contact information for the Provider.

In an embodiment, if a Provider inadvertently replies to multiple notifications regarding a particular Bid, then only the 1st response will trigger any functionality within the iBid System (such as e-mailing & billing, etc), and all additional responses are ignored.

In an embodiment, when a Provider makes an “Affirmative Response” to a Consumer Bid (by choosing to ‘Accept’, ‘Request More Information’, or ‘Counter’ only—to ‘Reject’ a Bid is not considered an “Affirmative Response”), the back-end programming automatically generates an e-mail to send the Consumer's contact information to the Provider, and the Provider's contact information to the Consumer. This information is not sent for any Bid that a Provider chooses to Reject.

In a variation, when a Provider chooses the ‘Request More Information’ or ‘Counter’ option in a Consumer Bid, they are directed to a form on the website that allows the opportunity to enter a new price or make additional comments to describe the terms of the Provider's counter offer (see FIG. 2). This information is included along with the Provider's contact information in their reply e-mail to the Consumer.

In other embodiments, there are a number of other situations in which the iBid System will be required to generate e-mails as well to communicate myriad other useful pieces of information to both Consumers and Providers, including billings, account status, system outages, special offers, etc.

### iBid System Core Functionality—Back-End Processing To Facilitate Automated Billing Transactions

In many embodiments, Providers pay a fee based on each Bid received. However, the treatment of a given Bid for billing purposes can vary according to the subscription level of a Provider, the validity of a given Bid, the continued availability of a Bid, and the rejection rate for a given Bid.

In another embodiment, before billing commences for the iBid System service, all registered Providers are granted a free trial on the site, during which time they shall receive unlimited free Bids until they make an Affirmative Response to a predetermined number of them, which in one variation is 10. In such a case, after a Provider responds affirmatively to 10 Bids, the Provider receives an e-mail communication that encourages the Provider to register with a credit card for the paid service. In yet another variation, Providers continue to receive all matching Bids even following the free-trial period, and upon each Affirmative Response, instead of receiving the Consumer's contact information, such Providers receive a notification to register for the paid service.

The functionality to register as a paid subscriber is built into the iBid System website. Following this free trial period, the back-end processing monitors the number of matching Bids each Provider receives during any given month, as well as the Providers' response (‘Accept,’ ‘Counter,’ ‘Request More Information’, or ‘Reject’) for each, and properly calculates the amount the Providers owe for the iBid System service based on the combined value of the Bids they have received, in accordance with the predetermined pay scales. In a variation, such pay scales follow the following protocol:
There are no recurring fees for using the iBid System. Instead, businesses or individual Providers are only charged for Bids they receive that specifically match their own criteria related to the products or services they offer, their location, and their minimum price.
The price per Bid is determined by the following scales, based on the number of possible competitors for any Bid and the amount offered by the Consumer. Providers can select from any of the following payment options:

| Unlimited No. of | | Max. of 4 | | Max. of 2 | |
|---|---|---|---|---|---|
| Competitors | | Competitors | | Competitors | |
| Bid Amount | | Bid Amount (in | | Bid Amount (in | |
| (in US Dollars) | Price | US Dollars) | Price | US Dollars) | Price |
| 0-50 | 0.25 | 0-50 | 0.50 | 0-50 | 1.00 |
| 51-500 | 0.50 | 51-500 | 1.00 | 51-500 | 2.00 |
| 501-1000 | 1.00 | 501-1000 | 2.00 | 501-1000 | 4.00 |
| 1001-2500 | 1.50 | 1001-2500 | 3.00 | 1001-2500 | 6.00 |
| 2501-5000 | 2.00 | 2501-5000 | 4.00 | 2501-5000 | 8.00 |
| 5001-10,000 | 2.50 | 5001-10,000 | 5.00 | 5001-10,000 | 10.00 |
| 10,001+ | 3.00 | 10,001+ | 6.00 | 10,001+ | 12.00 |

Upon receiving any Bid matching their criteria, Providers can choose to reject the Consumer's offer for any reason. In this case, the price for receiving that Bid will be reduced by a predetermined amount, which in some embodiments is 50%.
For one-time transactions from individual Providers (if a person would to sell their personal automobile on iBidDenver.com, for example), individual Providers are charged the same amount per matching Bid as those who sell their products or services continuously (such as a car dealer). However, the total amount that may be accrued for any one-time sale shall not exceed a predetermined percentage of the “Minimum Bid” (in one variation, 5%) that has been set for the item, from the date the individual Provider registers with the iBid System, until the item finally sells.

In still more embodiments, there are different pay scales from which the Providers can choose. In one variation, three pay scales may be considered: The first does not limit the number of potential competing Providers for any given Bid; the second does limit the number of Providers who compete for any Bid to a predetermined total; for example only, five; and the third pay scale is the highest-priced option that limits the number of competing Providers to a predetermined total; for example only, three. These third pay scales provide a means for Providers to limit how many other Providers they compete with in exchange for higher subscriber fees or other consideration. In yet another variation, Providers can manage their accounts and change their pay scale at any time. (See FIGS. 4 and 9-14.)

In one embodiment, a simple overview of the logic underlying the iBid System billing functionality is as follows (refer to FIG. 7 for a process flow diagram depicting this embodiment):
Three Pay Levels, Corresponding to Three Separate Billing Groups:
   Three Competitors Group (A)
   Five Competitors Group (B)
   Unlimited Competitors Group (C)
Two Difficulties:
   Determining which group a particular Bid belongs to.
   Determining which Providers within a group should receive the Bid, so that Bids are fairly distributed among all Providers.
Solution:
When match is found, send Bid to all matching Providers, regardless of group:
1. Accept and properly process first three Affirmative Responses (‘Accept’, ‘Request More Information’, or ‘Counter’ only) from any group;
2. Review those responses to determine if any of them is from group (A), and
   If Yes: Group (A) becomes the default, and no further Affirmative Responses from any group should be accepted for this Bid. All Providers submitting an Affirmative Response from this point forward should receive an electronic communication (e.g., e-mail, SMS message, etc.) to indicate that the Bid is no longer available and that they will not be charged for it. (END)
   Or
   If No: Prevent all further Affirmative Responses from Group (A) only, and send an electronic communication (e.g., e-mail, SMS message, etc.) to all remaining affirmative responders from Group (A) to indicate that the Bid is no longer available and that they will not be charged for it. Continue to step 3.
3. Accept two more Affirmative Responses from either of the remaining Groups (B) and (C) only.
4. Review all five Affirmative Responses received to this point in order to determine if any of them is from Group (B), and
   If Yes: Group (B) becomes the default, and no further Affirmative Responses from any group should be accepted for this Bid. All Providers submitting an Affirmative Response from this point forward should receive an electronic communication (e.g., e-mail, SMS message, etc.) to indicate that the Bid is no longer available and that they will not be charged for it. (END)
   Or
   If No: Prevent all further Affirmative Responses from Groups (A) and (B) only, and send an electronic communication (e.g., e-mail, SMS message, etc.) to all remaining Providers who submit an Affirmative Response from Group (A) or (B) to indicate that the Bid is no longer available and they will not be charged for it. Continue to step 5.
5. Accept and properly process all further Affirmative Responses from Group (C).
6. Always process all negative responses (“Reject”) from all groups according to the ordinary predetermined fee reduction (in some variations, 50%).
7. If a Provider fails to reply to any Bid within 24 hours, treat it as a “Reject” response and process it according to the ordinary 50% fee.
Note: In variations, this algorithm includes the flexibility to allow Providers who are no longer eligible to make an Affirmative Response to a Bid from within their own billing group to still have the option ‘Accept’ it (at a lower fee) as part of a different group, if they so desire, without contravening the logic provided by these rules.
   In another variation, relating to the priority of highly rated providers, the billing algorithm can be modified so that only Providers with high overall consumer ratings (for example, 4 stars or greater (on a scale of zero to five stars) on a minimum of a predetermined number of Consumer reviews) are eligible to register for the Group A billing group; that is, no more than two competitors for the Provider on any particular Bid. This ensures that when a Consumer receives a limited number of replies, the odds are greater that the businesses they hear from will be of high quality.

The above billing-algorithm is designed to ensure that the search results will be weighted such that Bids are fairly distributed across the three pay scales and guarantees that all Providers have an equal opportunity to win a meaningful Bid, even given the limitations that result from enrolling in either of the more competitive groups.

In other variations, the iBid System also includes integration with merchant-account services (e.g., FirstData/Authorize.net) that allows the iBid System to collect and store Provider credit-card information and bill Providers appropriately. In an embodiment, a billing statement is automatically e-mailed to each Provider every month to show the amount of activity they had on the website, as well as a comprehensive summary of their transactions.

In a variation, all billing functionality with an iBid System website is automated, although the website Administrator is able to manually select the particular date that billing is to occur. In other variations, this automated billing system process should include the following steps:

1. Properly calculate the monthly bill for each Provider in accordance with predetermined pricing guidelines, based on the number of Bids received and the choice of Accept/Counter/Request More Information/Reject for each.

2. Automatically charge each Provider credit card on the first day of every month (or any other date manually selected by the site Administrator). HOWEVER: If a Provider's bill is less than $5, the iBid System, in some embodiments, may continue to accrue charges through the next billing cycle, and not bill the credit card until the total amount is more than $5.
Exception: If a Provider unsubscribes from the iBid System, the Provider's payment should be processed immediately, even if the balance is less than $5.
This exception also applies to Providers whose current status on the site is either ‘10-Days Grace’ or ‘Past-Due.’ When these Providers update their credit card information, their payment should be processed immediately, rather than at the end of the next billing cycle. (For more information, refer to Provider Status, discussed infra.)

3. Send the appropriate Monthly Billing Statement e-mail to each Provider, which summarizes the details of their activity on the web site, and indicates whether the billing transaction was successful or unsuccessful.

4. Send a report to the iBidDenver Administrator to summarize the number of successful transactions for each billing cycle, including the total amount earned for the month, as well as the number of unsuccessful transactions, including the total amount still owed.

Note: In an embodiment, when a Provider's billing transaction is unsuccessful, their status on the website should automatically change to “10-Days Grace.” These Providers still receive and are able to properly reply to all Bids matching their criteria during this 10-day grace period.

In a variation, if no payment has been made within 10 days, the iBid System should automatically change a non-paying Provider's status to ‘Suspended.’ In some embodiments, suspended Providers still receive all Bids matching their criteria; however, selecting Accept/Counter/Request More Information/Reject in their Bid notifications does not trigger the ordinary e-mailing/SMS/telephone notification functionality (sending reciprocal contact information between the Provider and the Consumer). Rather, in such cases a Provider receives an electronic communication that encourages them to make a payment so that full services can be resumed.

In many embodiments, the iBid System database permanently stores information regarding all invoicing and payment transactions for every Provider, for administrative, tax, and accounting purposes.

### iBid System Core Functionality—User Interfaces

In most embodiments, the iBid System functionality is accessed by both Consumers and Providers via web interfaces, telephones, and related technologies. In a typical embodiment, both consumers and Providers manipulate their accounts and initiate system actions by way of a series of interactive webpage forms that are used to collect information to facilitate the various business processes discussed herein. In a variation, the following are key data fields that are populated after capturing this information via the various webpage interfaces:

Provider Data Fields

| | Required or | | | |
|---|---|---|---|---|
| Field Name | Optional | Type | Include On | Functions |
| Business Name | Optional | Text Box | Web Registration | |
| Contact Title | Optional | Drop-Down Menu | Form; Accept or | |
| Contact First Name | Required | Text Box | Counter E-mail to | |
| Contact Last Name | Optional | Text Box | Consumers; All | |
| | | | Email to Contractors | |
| Street Address | Optional | Text Box | Web Registration | |
| City | Optional | Text Box | Form; Accept or | |
| State | Optional | Text Box or Drop- | Counter E-mail to | |
| | | Down Menu | Consumers | |
| Postal Code | Optional | Self-Formatting | Web Registration | |
| | | Numeric | Form; Accept or | |
| Phone (Business or | Optional | Self-Formatting | Counter E-mail to | |
| Home) | | Numeric | Consumers | |
| Fax | Optional | Self-Formatting | | |
| | | Numeric | | |
| E-Mail address | Required | Text Box | | |
| Website Address | Optional | Text Box | | |
| Image or Logo | Optional | Image Upload | | |
| Minimum Bid | Required | Self-Formatting | Web Registration | Match to Consumer |
| Desired | | Numeric | Form; All E-mail to | Bid Field |
| | | | Contractors | |
| Maximum Bid | Optional | Self-Formatting | Web Registration | Match to Consumer |
| Desired | | Numeric | Form Only | Bid Field |
| Business Description | Optional | Text Box | Web Registration | |
| | | | Form; Accept or | |
| | | | Counter E-mail to | |
| | | | Consumers | |
| Categories | Required | Self-Populating | Web Registration | Match to Consumer |
| | | Drop-Down List | Form; All E-mail to | Category Field |
| | | | Contractors | |
| Locations | Required | Interactive Map | Web Registration | Match to Consumer |
| | | | Form; Accept or | Locations Field |
| | | | Counter E-mail to | |
| | | | Consumers | |
| Average Rating | | Calculate Average | Accept or Counter | Calculate from |
| | | (one to five stars) | E-mail to | Ratings Form |
| No. of Successful | | Count | Consumers Only | Calculate from |
| Transactions (three | | | | Ratings Form |
| stars or higher) | | | | |

Consumer Data Fields

| | Required or | | | |
|---|---|---|---|---|
| Field Name | Optional | Type | Include On | Functions |
| First Name | Required | Text Box | Web Registration | |
| Last Name | Required | Text Box | Form; Web Search | |
| | | | Form; Search | |
| | | | Confirmation Page; | |
| | | | Accept or Counter | |
| | | | E-mail to | |
| | | | Contractors; All | |
| | | | Email to Consumers | |
| Phone (cell) | Optional | Self-Formatting | Web Registration | |
| | | Numeric | Form; Web Search | |
| E-mail Address | Required | Text Box | Page; Accept or | |
| | | | Counter E-mail to | |
| | | | Contractors | |
| Categories | Required | Self-Populating | Web Search Page; | Match to Provider |
| | | Drop-Down List | All Bid Related E- | Category Field |
| | | | mail to Contractors; | |
| | | | All E-mail to | |
| | | | Consumers | |
| Description of | Required | Large Text Box | Web Search Page; | |
| Product or Service | | | All Bid Related E- | |
| Locations | Required | Interactive Map | mail to Contractors | Match to Provider |
| | | | | Locations Field |
| Bid Amount | Required | Self-Formatting | Web Search Page; | Match to Provider |
| | | Numeric | All Bid Related E- | Minimumm Bid and |
| | | | mail to Contractors; | Maximum Bid |
| | | | All E-mail to | Fields |
| | | | Consumers | |

Provider Rating Data Fields

| | Required or | | | |
|---|---|---|---|---|
| Field Name | Optional | Type | Include On | Functions |
| Title | Optional | Drop-Down Menu | Ratings form; | |
| First Name | Optional | Text Box | “Ratings Received” | |
| Last Name | Optional | Text Box | E-mail to Providers | |
| Provider Name | Required | Text Box | | Post to Ratings |
| Type of Product or | Required | Self-Populating | | Webpage |
| Service Provided | | Drop-Down List | | |
| Date Service/Good | Optional | Self-Formatting | | |
| Provided | | Numeric | | |
| Rating | Required | Numeric (with an | | Post to Ratings |
| | | associated Star | | Webpage; Calculate |
| | | Graphic) | | Provider Rating |
| | | | | from this field; |
| | | | | Calculate number of |
| | | | | successful |
| | | | | transactions from |
| | | | | this field |
| Comment | Optional | Large Text Box | | Post to Ratings |
| | | | | Webpage |

### iBid System Core Functionality—Consumer Ratings For Providers

In some embodiments, the iBid System provides a means for Consumers to enter the Consumers' ratings for specific Providers based on the Consumers' experience with any given Provider. In many variations, the ratings are quantified along a numeric scale (e.g., 1-5, 1-10, etc.), and often are displayed with some sort of graphical imagery, such as a plurality of stars. In an embodiment, a web-based form is provided to a Consumer to provide feedback regarding the products or services they have obtained through the iBid System service. In addition to providing a quantified rating, Consumers in other embodiments can also provide textual comments in their own words to provide feedback regarding any Provider with whom they have done business.

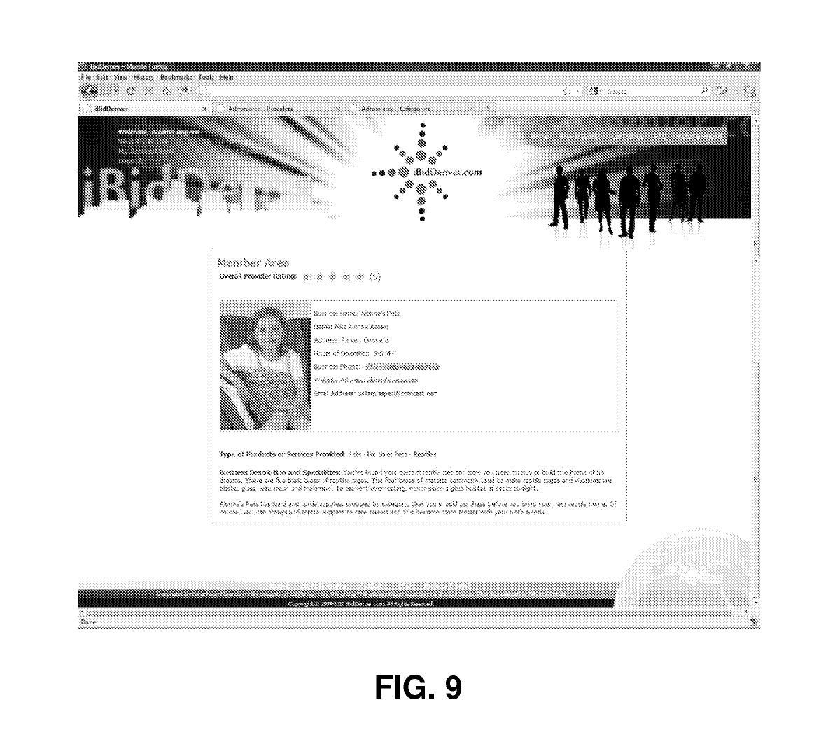

In variations, a web link to a feedback/ratings form is only sent to a Consumer for a Provider that the Consumer has received an Affirmative Response (‘Accept’, ‘Request More Information’, or ‘Counter’ only) from after the Provider matched the criteria specified in the Consumer's Bid. In further embodiments, when a Consumer rating and/or feedback comments about a Provider are received by the iBid System, the affected Provider is notified of the details via electronic communications; e.g., e-mail, SMS, etc. Alternatively, in a variation, the Provider is notified via a web link so that the Provider can navigate to a webpage that contains the details of the consumer feedback and rating. See FIG. 9 for one embodiment of a Consumer-Ratings review webpage.

In a variation, the Consumers can assign a rating to a Provider for each of the following criteria:
Timeliness
Professionalism
Communication
Courtesy
Value of Product or Service
Quality of Product or Service
Overall Consumer Experience With Provider

In an embodiment, the iBid system calculates the average rating score for display as the overall Consumer rating of the Provider.

iBid System Core Functionality—Provider Status Management

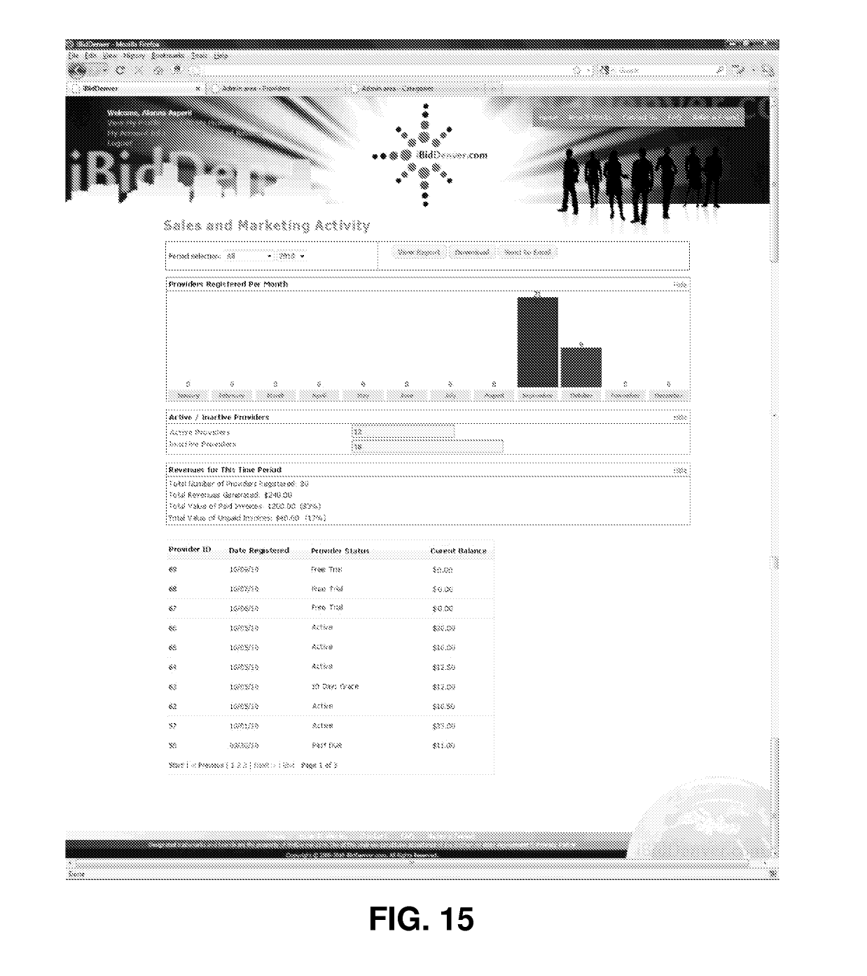

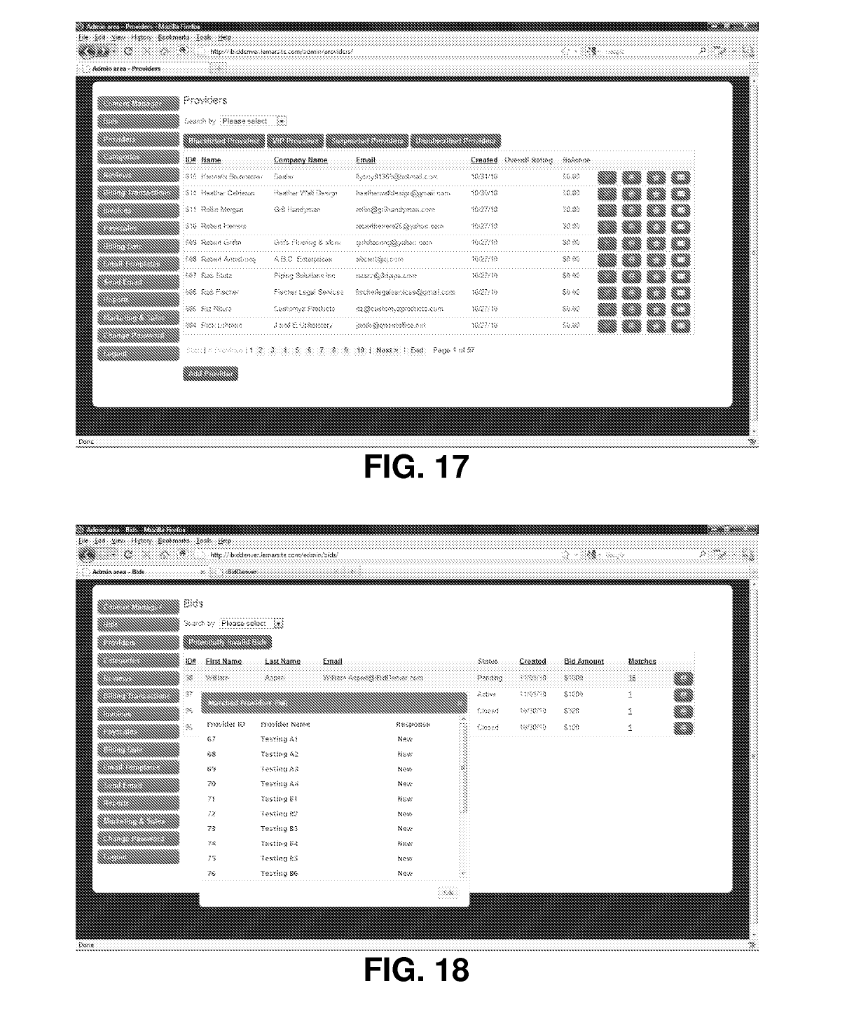

In an embodiment, Providers are automatically tracked according to a plurality of status codes, which can affect the types of notifications and other treatments (such as different levels of iBid System features access/participation, billing treatment, etc.) In addition, reports are typically made available to an iBid System Administrator using a web interface. See, e.g., FIGS. 15 and 17-18. In one variation twelve Provider statuses are defined as follows:

Provider Status Privilege Summary

| | | | Reply | |
|---|---|---|---|---|
| Provider | Login/Update | Receive | Affirmatively | Billed |
| Status | Account | Bids | to Bids | for Bids |
| Registered | Yes | No | No | No |
| Free Trial | Yes | Yes | Yes | No |
| Pending | Yes | Yes | No | No |
| Active | Yes | Yes | Yes | Yes |
| Suspended | Yes | No | No | No |
| 10-Days Grace | Yes | Yes | Yes | Yes |
| Past-Due | Yes | Yes | No | No |
| Blacklisted | No | No | No | No |
| Unsubscribed | No | No | No | No |
| V.I.P | Yes | Yes | Yes | No |
| Waiting | No | Yes | No | No |
| Invited | No | Yes | No | No |

In some embodiments, when a Provider has multiple statuses assigned, the following algorithm is implemented:
VIP status never takes priority.
Blacklisted status always overrides all other priorities.
Unsubscribed status takes priority over VIP status and Suspended status, but not Blacklisted status.
Suspended status takes priority over VIP status, but not over Blacklisted or Unsubscribed status.

To further explain the immediately preceding algorithm, a reference to the iBid System Administrator “Provider Status” web interface, which allows control over Provider status, is needed: On this interface, only “VIP,” “Blacklisted,” “Unsubscribed,” and “Suspended” are listed as checkboxes; all other statuses are included on a drop-down menu, in an embodiment. In that embodiment, the algorithm applies only to the priority among multiple statuses when each is represented with a checkbox (i.e., VIP +Unsubscribed); however, it does not apply if a Provider is assigned to multiple statuses, and some have a checkbox and the other is from the drop down menu (i.e., Active+Unsubscribed). In the latter case, the status with a checkbox (i.e., “Unsubscribed”) always takes priority.

### Summary of Key Advantages of the iBid System And Methods

Because of various novel features, discussed supra, there are also a number of features unique to various embodiments of the iBid System that differentiate it from similar web-based ‘matching’ applications including, among others:
The ability for users to advertise and to search for any product or service whatsoever, either within a local market or worldwide.
The ability for Consumers to indicate their own price for any product or service whatsoever, and be matched against business and individual-service Providers, either locally or globally, in order to satisfy the criteria specified in a Consumer's search.
The ability for business or individual-service Providers to select an unlimited number of categories in order to describe the types of products and/or services they hope to sell, the geographical area to be serviced by the Provider, as well as indicate a specific price range for each product/service individually, against which all Consumer Bids are matched. In short, the iBid System allows for Providers to easily market their goods and/or services over multiple marketing channels.
A matching algorithm which ensures that Provider listings never expire, but rather remain just as relevant many months after posting as they are on the day they are listed. That is, if there is a Consumer search/Bid that can still match the criteria of an old offering listed by a still-subscribed Provider, then the Provider may still be contacted about the qualified Bid.
The ability for Consumers or business and individual Providers to create new categories to describe the products or services pertinent to them, which allows the flexibility required in order to buy or sell literally anything at all, and eliminates the burden of accurately describing products or services within the limitations of a rigorous and predetermined set of criteria.
The ability for Consumers to select and search a predetermined number of categories simultaneously when entering Bids for products or services. In one embodiment, the predetermined number is three.
A Bid-tracking system that allows iBid System administrators to review all pertinent information regarding any Consumer Bid, including all information submitted in the Bid, the number and name of every Provider who received it, their responses to it, etc.
The existence of a series of iBid System affiliated websites distributed worldwide, each of which has a unique web address (such as iBidDenver.com, iBidNewYork.com, iBidLosAngeles.com, iBidChicago.com, iBidKharkiv.com, etc.) yet utilizes a single, unified database in order to process all transactions throughout the entire iBid System.
The use of a unique virtualized map within each localized market area of the iBid

System-affiliated network which is separated into pre-determined number of substantially equally-sized geographic zones and used as a means to indicate the area within which Providers can sell their products or services, and within which Consumers can search. For example, in one embodiment, the iBidDenver.com implementation of the iBid System is logically separated into nine geographical zones.
The use of e-mail notifications generated by the iBid System to facilitate business transactions in their entirety between Consumers and Providers. This also includes the functionality embedded within “Consumer Bid Received” e-mails to Providers which allows them the opportunity to either accept/counter/reject/request more information regarding any Consumer Bid directly from the message, and immediately receive Consumer contact information (either via e-mail, SMS message, or telephonic communications, in some embodiments) without requiring them to log onto the website.
A web-based system which integrates five distinct, yet inextricably interrelated, functional parts:
   A user interface for iBid System Consumers to place Bids for any product or service whatsoever;
   An interface for individual or business Providers to register any product or service whatsoever for sale, and track their Bidding history on the site;
   An interface for iBid System Administrators that allows them to track all transactions within the worldwide system and generate reports essential for tax and accounting purposes;
   An interface for iBid system Marketing Affiliates (which may be either Marketing companies or individual Sales Agents), all of whom may also generate reports to summarize their own sales and marketing activities for the site; and
   An interface for Consumers to create an iBid System account to store their contact information and track their bidding history on the site.
The designation of a predetermined number of distinctive types of Provider status to describe Providers' level of participation on the site; their ability to receive, ‘Accept’, ‘Counter’, or ‘Request More Information’ Consumer Bids; and whether or not they are billed for the Bids they receive.
The designation of a predetermined number of types of Bid Status which describe the number of Providers any Bid has been matched to, if any, as well as whether any Bid is valid or invalid, and determine whether it has received any affirmative responses (‘Accept’, ‘Counter’, or ‘Request More Information’ only), etc.
The designation of a predetermined number of types of responses business or individual Providers can make to any Bid.
The designation of a predetermined number of types of Provider registration which relate to how their product/services information was added to the Ibid System database and the means through which they ultimately become active members on the site.
The ability for Providers to reject a Bid and thereby reduce the fee for receiving it by a predetermined amount or percentage.
An algorithm for a group of Providers to mark a Bid as potentially ‘invalid’ and thereby obtain a refund.
A billing algorithm that offers Providers a full refund if they attempt to make an

Affirmative Response to a Bid but are precluded from receiving the Consumer's contact information due to the constraints of the iBid System Billing Algorithm.
The functionality to match new individual or business Providers backward in time against still-active Consumer Bids, either when they register for the site or modify any criteria pertinent to the matching algorithm (i.e., the categories that represent the products or services they offer, their location, and/or the price range for each of their wares).
The ability for Providers to choose from among a predetermined number of different pay scales which account for the level of competition for any Bid (that is, how many different Providers get to respond to any given Consumer Bid, as well as the amount offered by the Consumer for the product or service they seek).
Several unique algorithms which govern the iBid System matching, billing, and ‘invalid Bid’ functionality, among others, discussed supra.

### Alternative Embodiments And Other Variations

The various embodiments and variations thereof described herein (including the appended claims) and/or illustrated in the accompanying figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising a myriad of obvious variations and improvements to the invention, all of which are intended to be encompassed within the scope of the claims which follow.

What is claimed is:

1. A computer-implemented method for facilitating transactions, comprising the steps of:
receiving, at a server computer system, an offer from a first user via a first client computing system that is communicatively coupled with said server computer system; and
by said server computer system, matching said first user offering with at least one second user's offerings, said second-user offerings stored within said server computer system.

2. The computer-implemented method of claim 1, wherein said matching is based on a plurality of criteria, including:
at least one first-user-requested category of goods and/or services, as compared to said second user's offering of goods and/or services;
at least one first-user-selected, server-computer-system predefined, geographical location, as compared to said second user's geographical territory for offering goods and/or services, as recorded within said server computer system; and
a price offering, as compared to said second user's minimum acceptable price, as recorded with said server computer system.

3. The computer-implemented method of claim 1, further comprising the steps of:
by said server computer system, after a match between said first user's offerings and said second user's offerings is found, sending an electronic notification to said second user,
wherein said notification provides said second user with said first user's offer details, and
wherein said notification provides an means for said second user to electronically respond to said first-user offer; and
by said second user, on a second client computing system, electronically communicating a response to said server computer system.

4. The computer-implemented method of claim 3, wherein said electronic communication of said second-user response is selected from the group consisting of e-mail, SMS messaging, telephonic communications, and website access.

5. The computer-implemented method of claim 3, wherein said response is of a type selected from the group consisting of ‘Accept’, ‘Counter’, ‘Request More Information’, and ‘Reject’.

6. The computer-implemented method of claim 5, further comprising the step of:
by said server computer system, if said second user has responded by accepting (‘Accept’), making a counter offer (‘Counter’), or requesting more information (‘Request More Information’), then sending an electronic notification to said first user, wherein said notification provides said first user with said second user's acceptance, request for more information, or counter offer details.

7. The computer-implemented method of claim 3, wherein said second-user electronic notification is sent to all second users identified by said server computer system.

8. The computer-implemented method of claim 3, wherein said second-user electronic notification is sent to a subset of all second users matched by said server computer system, said subset determined randomly by said server computer system.

9. The computer-implemented method of claim 8, wherein said second-user electronic notification for each subsequent first-user offering involving the same category of goods and/or services is sent to a different subset of all second users matched by said server computer system until all matched second users have had an opportunity to respond to a first-user offering.

10. The computer-implemented method of claim 8, wherein if a second user pays a predetermined premium-membership fee, then said server computer system is programmed to increase the odds that said premium-member second user will be selected in said random selection for electronic notification of a first-user offering.

11. The computer-implemented method of claim 3, wherein each said second user is assigned a billing group from a predetermined set of billing groups in said server computer system, each billing group defining a different limit to the number of potential competitors a second user must compete with in responding to any first-user offering, said method further comprising the step of:
by said server computer system, automatically charging said second user charged a predetermined fee, according to said billing group pay scale, for each match with a first-user offering.

12. The computer-implemented method of claim 11, wherein said second-user billing group is selected from a group consisting of a three-competitors group, a five-competitors group, and an unlimited competitors group.

13. The computer-implemented method of claim 11, wherein:
said server computer system is programmed to accumulate and calculate an overall performance rating for individual second users based on electronically submitted feedback from first users regarding experiences with individual second users; and
said performance rating is assigned according to a predetermined quantitative scale;
said method further comprising the step of:
if said second user's overall performance rating is greater or equal to a predetermined threshold, based on a plurality of different first-user ratings, and if the total number of said first-user ratings are greater than or equal to a predetermined threshold, then before said matching step, allowing said second user to select inclusion into a preferred limited-competition billing group.

14. The computer-implemented method of claim 11, further comprising the step of:
if said second user is assigned a billing group for which said server computer system has programmatically blocked said second user from responding to a first-user offering, then allowing said second user to change the billing group and related fee schedule for said second user in order to allow said second user's participation in said first-user offering.

15. The computer-implemented method of claim 2, further comprising the steps of:
allowing said second user to modify said second user's matching criteria, as recorded within said server computer system;
by said second user, modifying said second user's matching criteria, as recorded within said server computer system; and
by said server computer system, making all still active first-user offerings that match said second user, based on said modified matching criteria, available to said second user for response.

16. The computer-implemented method of claim 11, further comprising the steps of, before said charging step:
by said server computer system, determining which billing group a second user is assigned; and
by said server computer system, if said first-user offering is rejected by said second user, then reduce said pay scale by a predetermined amount or percentage.

17. The computer-implemented method of claim 11, further comprising the steps of, before said charging step:
by said server computer system, determining whether said first-user offering has a rejected status as a result of expiration past a predetermined time period, or if said first-user offering is rejected by said second user, and if so, then
by said server computer system, reducing said second user's pay scale by a predetermined value or percentage.

18. The computer-implemented method of claim 11, further comprising the steps of, before said charging step:
by said server computer system, determining whether said first-user offering has a belated status as a result of said server computer system detecting that enough affirmative responses; that is, accepting (‘Accept’), making a counter offer (‘Counter’), or requesting more information (‘Request More Information’); for said first-user offering have already been received according to a predetermined threshold, and if so, then
by said server computer system, allowing said second user to accept an opportunity to move to a billing group with a higher number of competitors and with a correspondingly lower fee.

19. The computer-implemented method of claim 11, further comprising the steps of, before said charging step:
by said server computer system, determining whether said first-user offering has a declined status as a result of said server computer system detecting that enough affirmative responses; that is, accepting (‘Accept’), making a counter offer (‘Counter’), or requesting more information (‘Request More Information’); for said first-user offering have already been received according to a predetermined threshold, then
by said server computer system, allowing said second user to decline an opportunity to move to a billing group with a higher number of competitors and with a correspondingly lower fee, and thereby causing said second user to receive a full refund of corresponding fees that have been paid.

20. The computer-implemented method of claim 1, wherein said first user's offer comprises an activity selected from the group consisting of:
seeking an employment opportunity;
providing an offer to perform a temporary task that is subject to contract renewal;
providing an offer to enter into business with one or more second users;
providing an offer to purchase real estate; and
seeking dating companionship.

21. The computer-implemented method of claim 1, wherein said first user's offer is based on the primary professional expertise or secondary skills of said first user.
